(19) United States
(12) Patent Application Publication
(10) Pub. No.: US 2010/0170653 A1
(43) Pub. Date: Jul. 8, 2010

(54) SOLIDIFICATION OF MOLTEN MATERIAL OVER A MOVING BED OF DIVIDED SOLID MATERIAL

(75) Inventor: Robert J. Geertsen, Moses Lake, WA (US)

Correspondence Address: KLARQUIST SPARKMAN, LLP, 121 SW SALMON STREET, SUITE 1600, PORTLAND, OR, 97204, US

(73) Assignee: REC Silicon Inc.

(21) Appl. No.: 12/684,035

(22) Filed: Jan. 7, 2010

Related U.S. Application Data
(60) Provisional application No. 61/143,098, filed on Jan. 7, 2009.

(51) Int. Cl. B22D 23/06; C22C 1/04; B22F 3/00; B32B 15/02

(52) U.S. Cl. 164/47; 75/388; 425/78; 428/546

(57) ABSTRACT

Systems and methods for converting a powder to a solid mass are disclosed. A furnace is provided to melt the powder and deliver a stream of resulting molten material to a bed of beads on a vibratory conveyor. Cooling gas flows through nozzles positioned above and along the conveyor to cool the beads and liquid. The liquid solidifies and forms a solid mass, incorporating beads from the bed. The conveyor can be periodically stopped to produce a plurality of discrete solid masses. Masses and unincorporated beads fall into a collection container. Unincorporated beads pass through a screening device and are returned to the bed of beads. A make-up bead system adds beads to the bed as needed to maintain a suitable bed depth. In some embodiments, the powder and beads consist essentially of silicon, and the solid masses formed are suitable for preparing silicon ingots.

### CROSS REFERENCE TO RELATED APPLICATION

This claims the benefit of U.S. Provisional Application No. 61/143,098, filed Jan. 7, 2009, which is incorporated herein by reference.

### FIELD

The present disclosure concerns a system and method for converting a powder of a meltable material to solid masses.

### BACKGROUND AND SUMMARY

High purity silicon powder is readily available and is a desirable feedstock for subsequent melting and purification. For example, silicon powder forms during pyrolysis of silane gas, i.e., SiH₄(g)→Si(s)+2H₂(g). The silicon powder formed during silane decomposition is a high purity powder of ultrafine polycrystalline silicon particles of submicron size, low bulk density and high surface area. However, the powder has several undesirable properties. It has a significant potential for dust explosion due to its combustible nature and very fine particle size, i.e., as small as 5 nm. Melting the powder utilizing standard processes and standard equipment is either difficult or impossible. In conventional processes where melting is possible, low yields are obtained because the powder's bulk density is as low as 6 to 10% of single crystal material density. Handling and processing the powder is difficult and messy without specialized equipment because the material easily becomes airborne. Finally, the powder has increased packaging, storage, and shipping costs due to its low bulk density.

Given these challenges, a need exists for a process to convert silicon powder into larger solidified chunks without introducing contaminants and without the need for expensive consumable molds or additional size reduction processing of the solidified chunks prior to subsequent melting and processing.

Described herein is a solidifier having a bed of beads on a conveyor. The bed is positioned to receive molten material from a discharge opening of a powder melting furnace. In some arrangements, the powder melting furnace is a rotary tube furnace. Vibratory drives are coupled to the conveyor. In certain arrangements, the drives are electromagnetic vibratory drives. Cooling gas flows through one or more nozzles positioned above and along the conveyor. A collection container including a screening device having openings dimensioned to allow passage of the beads is positioned at the downstream end of the conveyor. Beads passing through the screening device are returned to the conveyor upstream of the furnace discharge point. A make-up bead system provides additional beads to the bed.

In some arrangements, the solidifier components are housed within a solidification chamber, or vessel, defined by water-cooled walls and containing an inert atmosphere. The cooling gas and the inert atmosphere advantageously have identical or compatible chemical compositions.

A powder is melted within the furnace. The resulting molten liquid flows out through the discharge opening and onto the bed of beads. Advantageously, the beads and the powder have an identical or similar chemical composition with the purity level of the beads typically at least as high as the molten liquid. In particular instances, the bead purity is as high as economically practical to limit contamination of the solidified mass. Cooling gas flowing through the nozzles cools the beads and the molten liquid. The liquid solidifies into a mass, typically incorporating a plurality of beads into the mass as it solidifies. The bed of beads best will have sufficient depth to prevent contamination of molten material due to contact with a surface of the conveyor.

Additionally, molten material contact with the conveyor could cause fouling accumulations, which could limit the conveyor's ability to move material.

The conveyor may be periodically stopped as liquid flows onto the bed of beads and solidifies, thus producing a plurality of solidified masses. The solidified masses and unincorporated beads fall off the end of the conveyor and into the collection container. Unincorporated beads pass through the screening device and are returned to the bed of beads. A make-up bead system may be provided to add beads to the bed to replace beads incorporated into the solidified masses.

In some embodiments, each solidified mass consists essentially of a solid silicon mass and silicon beads. The solidified masses are suitable for preparing silicon ingots.

Objects, features, and advantages of the invention will be apparent from the following detailed description, which proceeds with reference to the accompanying figures.

### BRIEF DESCRIPTION OF THE DRAWINGS

In the drawings:

FIG. 1 is a schematic diagram of a system for converting a powder to a plurality of solid masses.

FIG. 2 is a photograph of a vertical cross section of a first silicon mass.

FIG. 3 is a photograph of the lower surface of the mass of FIG. 2.

FIG. 4 is a photograph of the upper surface of a second silicon mass.

FIG. 5 is a photograph of the lower surface of the mass of FIG. 4.

FIG. 6 is a photograph of a side view of the mass of FIG. 4.

### DETAILED DESCRIPTION

Disclosed herein are systems and methods for receiving a molten liquid stream from a powder melting furnace and subsequently converting the liquid back into a solidified form while maintaining very high purity levels and without using a mold. Suitable materials include but are not limited to aluminum, copper, germanium, iron, nickel, silicon, titanium, zinc, and zirconium. For example, silicon powder is melted and converted to a plurality of solid masses, e.g., chunks, of silicon. The molten liquid is solidified over a bed of finely divided material, advantageously as a continuous process. While the remainder of the discussion proceeds with reference to silicon, it will be understood by one of ordinary skill in the art that other meltable powders such as those listed above may be used with the described system and methods.

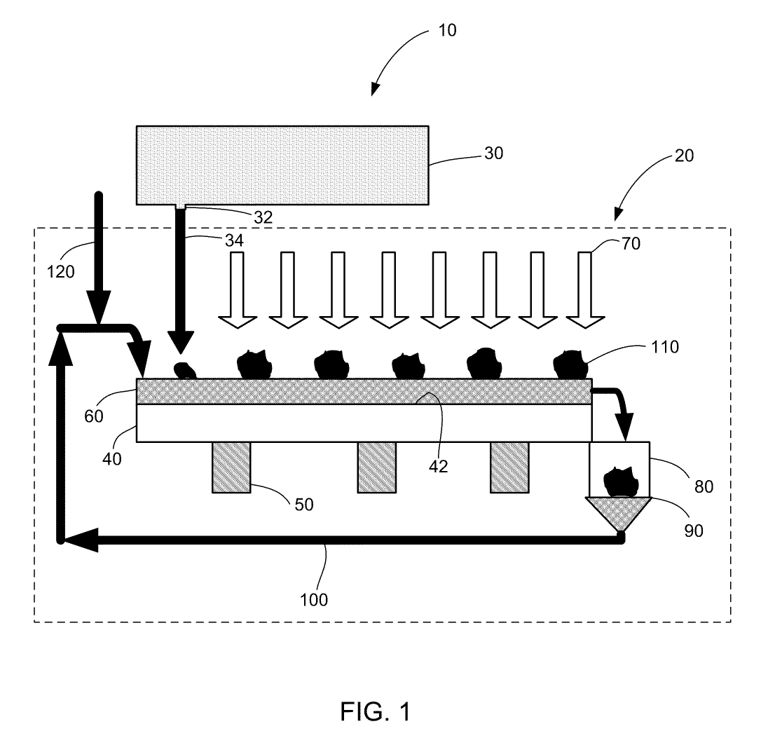

FIG. 1 shows a system 10 for converting a liquid to a solid mass. System 10 includes a solidifier 20 and a powder melting furnace 30. Solidifier 20 includes a conveyor 40, one or more drives 50, a bed 60 of beads, a plurality of cooling nozzles 70, a collection container 80, a screening device 90, and a bead return device 100.

The length and width of conveyor 40 are determined based upon a number of variables. These variables may include the speed of conveyor 40, the size of the solid masses 110 to be formed, the cooling capacity of the gas nozzles 70, and the combination of conveyor start and stop times. Parameters are selected to provide the solidified masses 110 with a residence time upon conveyor 40 that ensures the outer surface of the masses are sufficiently solidified to substantially prevent subsequent fusion to or contamination from screening device 90 and/or fusion to other masses. The width of conveyor 40 is selected to maximize retention on the conveyor of any liquid splash as liquid stream 34 contacts bed 60 or solidified mass 110. In some arrangements, conveyor 40 is 8-12 feet in length and 2-4 feet wide.

One or more drives 50 are operably coupled to the conveyor 40. In some arrangements, the drives 50 are vibratory drives that impart a vibratory motion to conveyor 40. The vibratory motion provides conveyor movement without sliding parts, which may be a source of contamination due to wearing of the parts. In particular arrangements, the drives 50 are electromagnetic vibratory drives. The vibratory conveyor's speed is infinitely adjustable and can be easily started and stopped with a pulsed motion. In other arrangements, a belt or bucket conveyor may be utilized if parts susceptible to frictional wear and any wear products are isolated from contact with molten liquid discharged from furnace 30, bed 60, solidified masses 110, and the cooling gas.

The conveyor 40 has an upper surface 42 that supports the bed 60 of beads. In some arrangements, upper surface 42 is coated with a silicon-based material to provide wear resistance. For example, upper surface 42 may be coated with silicon carbide or silicon nitride.

To produce solid masses of generally uniform composition, the beads of bed 60 and the molten liquid dispensed from powder melting furnace 30 have a substantially similar chemical composition. For instance, if the molten liquid is high-purity silicon, the beads are also high-purity silicon. As used herein, “substantially similar chemical composition” means that the beads' chemical composition is the same as the molten liquid other than minor amounts (e.g., less than 2 wt %) of impurities that may be present, and further means that the beads' purity varies less than ±1% compared to the molten liquid composition, such as less than ±0.5%, less than ±0.1%, or less than ±0.01% compared to the molten liquid composition (e.g., if the liquid is 99% pure silicon, then the beads are 99±0.01% pure silicon). Typically the molten liquid has a purity of at least 98%. Preferably, however, the molten liquid has a purity of least 99%, and more preferably a purity of at least 99.99%. Desirably, the beads are at least as pure as the molten liquid. Thus, if the molten liquid has a purity of 99%, the beads have a purity greater than or equal to 99%. In particular arrangements, the bead purity is as high as economically practical to limit contamination of the solidified mass. The acceptable variance in purity depends, at least in part, on the intended end use of the product. In some arrangements, both the molten liquid and the beads consist essentially of silicon.

The beads may have any geometric configuration, and may have a regular or irregular configuration. Typically, the beads are substantially spherical. In some arrangements, the beads are substantially spherical with an average diameter in the range of 0.1-3.0 mm, such as 0.5-2.0 mm or 0.75-1.5 mm.

The powder melting furnace 30 comprises a vessel suitable for containing a body of molten material. Suitable powder melting furnaces include arc melting furnaces, reverbatory furnaces, rotary furnaces, tower furnaces, and vacuum furnaces. In some arrangements, a rotary furnace is used. Suitable powder melting furnaces are manufactured, e.g., by Harper International Corp., Lancaster, N.Y. An exemplary rotary tube furnace is described in WO 2009/139830, which is incorporated herein by reference. In the illustrated arrangement of FIG. 1, the vessel of furnace 30 has a discharge opening 32 positioned above bed 60. Typically, the discharge opening is positioned 100 cm to 200 cm above bed 60. In some arrangements, the height may be less than 100 cm if the physical constraints of the apparatus are such that a reduced height is possible. Desirably, the height is minimized to contain any splash trajectory such that the splash is confined to the width of bed 60 and does not splash higher than cooling nozzles 70 or other structures above bed 60. Discharge opening 32 has a cross-sectional area sized to permit a molten stream 34 of liquid to pass through the opening while minimizing radiative heat transfer from the furnace 30. In some arrangements, the molten stream 34 may pass through discharge opening 32 with a flow rate up to 50 kg/hour. In a particular arrangement, the flow rate is 25 kg/hour.

The furnace 30 is operated to increase the temperature of the powder contained in the vessel to a temperature greater than the melting point of the powder and thereafter to maintain the elevated temperature. If the powder is silicon, the furnace is operated to maintain the contents of the vessel at a temperature above silicon's melting point, i.e., above 1414° C. For example, the temperature may be maintained at 1450° C. to 1600° C. or from 1500° C. to 1550° C. When melting silicon, it is best to maintain an inert atmosphere within the vessel of the furnace 30. Typically, the inert atmosphere is argon, hydrogen, helium, or any combination thereof. Hydrogen and helium have excellent thermal conductivity. However, argon typically is used since it is less hazardous than hydrogen and less expensive than helium.

A liquid stream 34 of silicon flows through discharge opening 32 onto bed 60. In some arrangements, liquid stream 34 has a flow rate of 25 kg/hour. However, flow rate can be reduced to produce smaller masses 110 and/or to optimize solidification. The liquid silicon 34 begins to transfer heat to the surrounding environment as it falls toward bed 60.

In certain arrangements, the solidifier 20 includes a solidification vessel (not shown) having a chamber at least partially defined by cooled chamber walls. The chamber walls may, for example, be water cooled and may have a surface treatment or coating capable of absorbing radiant heat. Conveyor 40 is housed within the solidification chamber. When operating with reactive or high purity materials such as high purity silicon, an inert atmosphere can be maintained within the solidification chamber. In some arrangements, the solidification vessel is gas tight. In other arrangements, solidification vessel is operated at positive pressure to minimize or prevent entry of the surrounding atmosphere into the vessel. In some instances, the inert gas in the vessel of furnace 30 and the inert atmosphere in the solidification chamber have an identical or substantially similar chemical composition and may be supplied from a common gas source. The gas may be argon, hydrogen, helium, or any combination thereof. The gas optionally is recycled.

Further cooling of the masses 110 and bed 60 is provided by a directed flow of cool, inert gas through a plurality of cooling nozzles 70 positioned along the length of the bed. In some instances, the inert gas advantageously is of the same composition as the inert atmosphere within both the furnace 30 and the solidification chamber. In other instances, the inert gas in the vessel and the inert atmosphere in the solidification chamber have different compositions. For example, when argon is used in the vessel of furnace 30, hydrogen and/or helium may be added to argon in the solidification chamber to increase the thermal conductivity and effectiveness of the gas passing through cooling nozzles 70. In some arrangements, the bed 60 of silicon beads is maintained at a relatively low temperature to facilitate solidification. For example, the temperature of the bed 60 may be maintained at less than 25° C., less than 50° C., less than 100° C., or less than 150° C. In certain arrangements, bed 60 may be cooled even further, e.g. to −100° C., to limit bead incorporation into solidified masses 110 and/or to increase throughput.

As the liquid silicon stream 34 falls through the cool inert atmosphere, it loses thermal energy through convective heat transfer and begins to solidify. As cooling stream 34 contacts the relatively cold silicon beads in bed 60, it rapidly solidifies due to continued radiative and convective heat transfer to the environment along with conductive heat transfer to the beads. As the silicon solidifies on bed 60, it forms a solidified mass 110. Typically a plurality of silicon beads from bed 60 is incorporated into the lower surface of mass 110 as it solidifies. The resulting solidified mass includes a plurality of beads embedded (i.e., set securely) in the mass. In some examples, the solidified mass includes up to 40 wt % beads, such as up to 30 wt % beads, or up to 20 wt % beads. The lower limit of bead incorporation may depend, at least in part, on the economics of the operation. Generally the resulting solidified mass includes at least 2 wt % beads, at least 5 wt % beads, or at least 10 wt % beads. In a working embodiment, it was found that about 14 wt % of a solidified mass 110 consisted of beads.

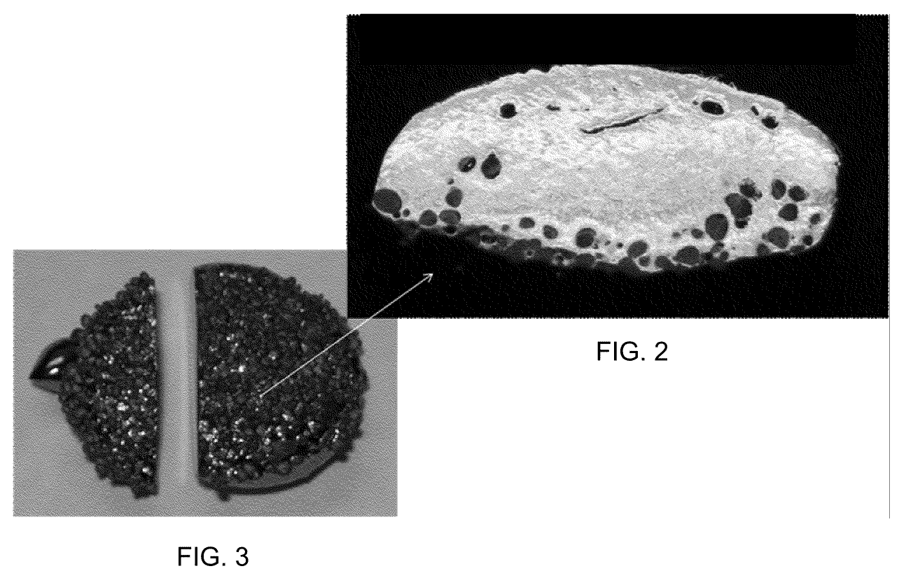

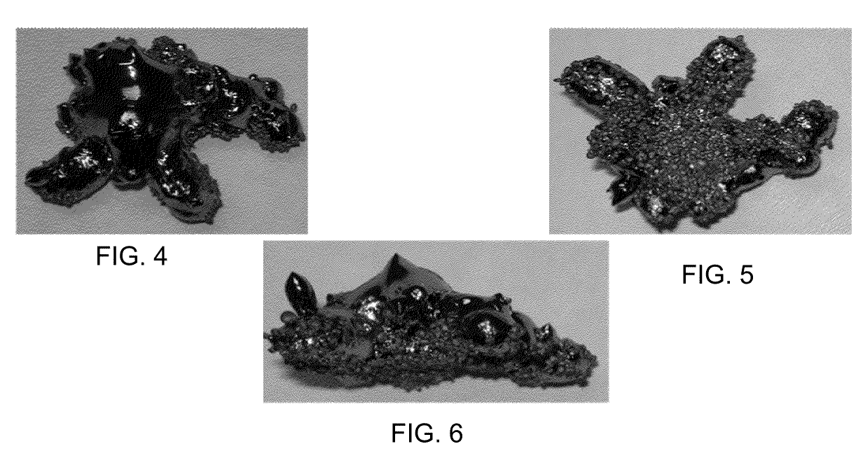

FIGS. 2-6 are photographs of solidified silicon masses formed as described herein. FIG. 2 is a cross-section of a silicon mass having a diameter, as viewed from the top, of about 22 mm. FIG. 3 is a photograph of the lower surface of the mass in FIG. 2, showing the incorporated beads. FIGS. 4-5 are photographs of the upper and lower surface, respectively, of a silicon mass formed as described herein. FIG. 6 is a side view of the mass in FIGS. 4-5. As shown in the cross-section of FIG. 2, some beads may be fully embedded within the solidified mass. Other beads are partially embedded in the mass as shown in FIGS. 3-6, i.e., a portion of the bead is embedded while the remainder of the bead protrudes from a surface of the solidified mass.

The percentage of beads within the solidified mass varies depending upon the size of the mass. For example, as an initial layer of liquid silicon cools and solidifies on the upper surfaces of the cooled beads, the relatively low thermal conductivity of silicon causes a high thermal gradient, i.e., the top of the solidifying mass is at a significantly higher temperature than the lower surface of the mass. As additional liquid flows onto the solidifying mass, the lower surface of the mass remains solidified and no further incorporation of beads occurs. Thus, a larger mass has a lower relative percentage of incorporated beads compared to a smaller mass. To minimize costs associated with providing additional beads to the solidifier, the percentage of incorporated beads is minimized. However, in some arrangements it may be advantageous to allow a higher percentage of incorporated beads in order to provide increased throughput. When preparing masses for crucible packing and subsequent ingot casting, the maximum chunk size is slightly greater than 100 mm in diameter. In some arrangements, the chunks are less than 30-40 mm in diameter.

Referring to FIG. 1, the beads in bed 60 are maintained at sufficient depth to maintain a layer of unincorporated beads between the masses 110 and the conveyor 40. The layer of unincorporated beads prevents fouling accumulations from forming on the upper surface 42 of the conveyor 40 and also minimizes or prevents contamination of liquid 34 and masses 110 due to contact with the conveyor surface. Desirably, bed 60 is maintained at a depth of 2 cm to 10 cm, such as 4 cm to 6 cm.

Vibratory drives 50 can be adjusted to control the speed of conveyor 40. Typically, the conveyor moves beads at a speed of 30 to 1800 cm per minute. In particular arrangements, conveyor 40 is periodically stopped and restarted. For example, the conveyor may be stopped every 1 second to 25 seconds for a period of 5 seconds to 20 seconds to form discrete masses of a desired size. Adjusting the conveyor speed and/or periodically stopping conveyor 40 allows the operator to control the size of a mass 110, as will be understood by a person of ordinary skill in the art. For example, to produce a mass with a volume of 27 cm³ with a liquid stream 34 flow rate of 25 kg/hour, the conveyor would be stopped for approximately 9 seconds. If the conveyor has a speed of 900 cm per minute and the desired distance between masses is 15 cm, the conveyor would be run for 1 second between stopping points. Assuming a conveyor length of 300 cm from the deposition point to the end of the conveyor, the mass would remain on the conveyor for 200 seconds prior to discharge into the collection container.

Adjusting the conveyor speed and/or periodically stopping conveyor 40 also ensures that mass 110 is sufficiently solidified and cooled before reaching the end of conveyor. Desirably, the outer surface of mass 110 is solidified sufficiently to avoid fusion with other masses or beads and to avoid fusion with screening device 90. Additionally, mass 110 is sufficiently cooled before discharge into collection container 80 to minimize or prevent contamination of the mass from contact with screening device 90. In some arrangements, conveyor 40 provides continuous movement while liquid silicon 34 is flowing to produce elongated masses.

When a mass 110 reaches the downstream end of conveyor 40, it falls into a collection container 80 along with unincorporated beads from bed 60. When producing high purity materials, such as high purity silicon, the container should made of or lined with a non-contaminating material. A desirable material resists erosive wear and impact, withstands slightly elevated temperatures, is a good conductor of heat, and/or has a high segregation coefficient to enable subsequent melt directional solidification purification. For example, a high chrome steel may be a suitable material for collection container 80.

A screening device 90 is positioned at the bottom of the illustrated container 80. The screening device 90 has a plurality of openings which are dimensioned appropriately to allow unincorporated beads to pass through the openings while preventing the passage of masses 110. Desirably, a container 80 is sufficiently sized to collect several masses 110. In some arrangements, container 80 is shaken or vibrated to ensure that unincorporated beads fall through screening device 90. When container 80 is full, it is removed and replaced with an empty container. In some arrangements, container 80 is suitable for direct shipping of masses 110 to end users. For inert atmosphere operation, the system is constructed so that a full container can be removed from the solidifier housing through an air lock (not shown) or detached from an opening through the solidifier housing having a gas-tight door (not shown) to minimize the loss of inert gas during an exchange of containers. During a container exchange, conveyor 40 is stopped.

Beads that fall through screening device 90 can be returned to the bed 60 upstream of the furnace discharge opening 32. The beads are returned by any suitable device 100. For example, device 100 may be a conveyor. In particular arrangements, device 100 is a bucket conveyor.

As discussed above, a plurality of beads is incorporated into each mass 110 as liquid stream 34 contacts the bed 60 and begins to solidify. To compensate for the incorporated beads that are not returned to bed 60, a make-up bead system 120 is provided. Make-up bead system 120 delivers additional beads to bed 60 upstream of furnace discharge opening 32. Sufficient beads are added to maintain bed 60 at the desired depth.

Solidified silicon masses produced by embodiments of the disclosed method can be used to manufacture crystalline silicon ingots by any suitable method. For example, monocrystalline silicon ingots can be prepared by the Czochralski process. To begin the Czochralski process, one or more silicon masses are loaded into a cylindrical, rounded bottom crucible and melted. When the polysilicon in the crucible has thoroughly melted into a molten silicon mass, the primary function of the Czochralski process commences as one skilled in the art directs machinery to dip and withdraw a “seed crystal” into/from the molten silicon mass. By slowly withdrawing (or “pulling”) the seed crystal and carefully controlling the slow cooling rate, a single-crystal ingot can be “grown” to a desired size or weight.

Another suitable method for preparing silicon ingots is directional solidification. In the directional solidification process known to those skilled in the art, a generally rectangular, flat bottom container (herein called a “mold”) is filled with silicon masses and subsequently melted under an inert atmosphere. When the polysilicon contents of the mold, called the “charge,” have thoroughly melted to a desired state of a molten silicon mass, the bottom of the mold (and thus the charge contained inside) is allowed to cool in a controlled manner. As this cooling occurs, one or more crystals nucleate and grow upward in the charge, thereby pushing impurities out of the expanding crystal microstructure. This slow cooling process of the entire molten silicon mass allows the crystals to grow to a large size. Embodiments of exemplary methods for producing silicon ingots by directional solidification are described in U.S. Pat. No. 7,141,114, which is incorporated herein by reference.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

1. A system for converting a liquid produced in a powder melting furnace to a solid mass, comprising:
a furnace operable to receive and melt a powder to form a liquid and to discharge the liquid via a discharge opening;
a conveyor having an upper surface;
a bed of beads supported by the upper surface with at least a portion of the bed positioned beneath the discharge opening;
at least one drive operably coupled to the conveyor to cause supported material to move along the conveyor; and
a collection container positioned to receive material from the conveyor.

2. The system of claim 1 further comprising:
a source of a cooling gas; and
at least one nozzle connected to the source of cooling gas and positioned to convey cooling gas to material supported by the conveyor.

3. The system of claim 1 where the at least one drive is a plurality of vibratory drives.

4. The system of claim 1 wherein the beads and the liquid have a substantially similar chemical composition.

5. The system of claim 4 wherein the beads and the liquid consist essentially of silicon.

6. The system of claim 1 further comprising a screening device defining a plurality of openings that are dimensioned and positioned to allow beads to pass out of the collection container.

7. The system of claim 6 further comprising a conveyance for transporting beads from the collection container to the bed at a location upstream of the discharge opening.

8. The system of claim 1 further comprising a make-up bead system operable to deliver beads to the bed upstream of the discharge opening.

9. The system of claim 1 further comprising a solidification vessel containing at least the conveyor, the bed, and an inert atmosphere.

10. The system of claim 9 wherein the solidification vessel comprises cooled chamber walls.

11. The system of claim 10 wherein the chamber walls comprise a surface treatment capable of absorbing radiant heat.

12. The system of claim 10, further comprising:
a source of a cooling gas and structure defining at least one gas passageway in proximity to the chamber walls to conduct a flow of cooling gas along at least a portion of the chamber walls; and
wherein the cooling gas and the inert atmosphere have a similar chemical composition.

13. The system of claim 12 wherein the cooling gas comprises argon, helium, hydrogen, or any combination thereof.

14. A system for converting a powder to a solid mass, comprising:
a furnace, wherein the furnace is operable to melt a powder, the furnace further comprising a discharge opening;
a conveyor positioned beneath the discharge opening;
a bed of beads supported by the conveyor;
a plurality of vibratory drives operably coupled to the conveyor;
a plurality of nozzles positioned to convey cooling gas to material supported by the conveyor;
a collection container positioned to receive material from the conveyor;
a screening device defining a plurality of openings that are dimensioned and positioned to allow beads to pass out of the collection container;
a conveyance for transporting beads that pass out of the collection container to the bed at a location upstream of the discharge opening; and
a make-up bead system operable to deliver beads to the bed upstream of the discharge opening.

15. The system of claim 14 further comprising a solidification vessel that comprises cooled chamber walls and that contains at least the conveyor, the bed, and an inert atmosphere.

16. A system for converting a silicon powder to a solid silicon mass, comprising:
a rotary tube furnace operable to receive and melt a powder consisting essentially of silicon to form a liquid and to discharge the liquid via a discharge opening;
a conveyor having an upper surface;
a bed of beads supported by the upper surface with at least a portion of the bed positioned beneath the discharge opening, wherein the beads consist essentially of silicon;
at least one drive operably coupled to the conveyor to cause supported material to move along the conveyor; and
a collection container positioned to receive material from the conveyor.

17. The system of claim 16, further comprising:
a drive system operably coupled to the conveyor, wherein the drive system is configured to periodically start and stop the conveyor;
a solidification chamber, wherein at least the conveyor is positioned within the solidification chamber;
a plurality of nozzles positioned to convey cooling gas to material supported by the conveyor;
a screening device defining a plurality of openings that are dimensioned and positioned to allow beads to pass out of the collection container;
a conveyance for transporting beads that pass out of the collection container to the bed at a location upstream of the discharge opening; and
a make-up bead system operable to deliver beads to the bed upstream of the discharge opening.

18. A method for converting a powder to a solid mass, the method comprising:
melting a powder in a furnace to form a liquid;
depositing a flow of the liquid via a discharge opening onto a bed of beads supported by a conveyor, wherein the beads and the powder have a similar chemical composition;
cooling the bed of beads and the deposited liquid such that the liquid solidifies and forms a solid mass on the bed of beads;
moving the solid mass along the conveyor; and
collecting the solid mass.

19. The method of claim 18 further comprising converting the powder to a plurality of solid masses and collecting the plurality of solid masses.

20. The method of claim 18 wherein the powder and the beads consist essentially of silicon.

21. The method of claim 18 wherein the cooling the bed of beads and the liquid comprises flowing a cooling gas through at least one nozzle positioned to convey cooling gas to material supported by the conveyor.

22. The method of claim 21 wherein the cooling gas comprises argon, helium, hydrogen, or any combination thereof.

23. The method of claim 18 wherein the method is performed in an inert atmosphere.

24. The method of claim 23 wherein the cooling gas and the inert atmosphere have a similar chemical composition.

25. The method of claim 18 further comprising periodically stopping the conveyor as the liquid flows onto the bed of beads on the conveyor.

26. The method of claim 18 wherein the conveyor is a vibratory conveyor.

27. The method of claim 18 wherein the bed of beads has sufficient depth to avoid contamination due to contact of the liquid with the conveyor.

28. The method of claim 18 further comprising:
collecting the solid mass and unincorporated beads in a container; and
passing the unincorporated beads out of the container separately from the mass.

29. The method of claim 28 further comprising returning the unincorporated beads to the bed of beads upstream of the discharge opening.

30. A method for converting a silicon powder to a solid mass, the method comprising:
melting a powder in a rotary tube furnace to form a liquid, wherein the powder consists essentially of silicon;
depositing a flow of the liquid via a discharge opening onto a bed of beads supported by a conveyor, wherein the beads consist essentially of silicon;
cooling the bed of beads and the deposited liquid such that the liquid solidifies and forms a solid silicon mass on the bed of beads,
moving the solid silicon mass along the conveyor; and
collecting the solid silicon mass.

31. The method of claim 30, wherein cooling comprises flowing a cooling gas through a plurality of nozzles positioned to convey cooling gas to material supported by the conveyor, the method further comprising:
collecting the solid silicon mass and unincorporated beads in a container;
passing the unincorporated beads out of the container separately from the solid silicon mass; and
returning the unincorporated beads to the bed of beads upstream of the discharge opening.

32. A product, consisting essentially of:
a solid mass consisting essentially of aluminum, copper, germanium, iron, nickel, silicon, titanium, zinc, or zirconium; and
a plurality of beads embedded in the solid mass, wherein the beads and the solid mass have a substantially similar chemical composition.

33. The product of claim 32, wherein up to 40 wt % of the product consists of beads.

34. The product of claim 32, wherein the beads and the solid mass consist essentially of silicon.

35. A method for using a solidified silicon mass, the method comprising:
providing at least one solidified silicon mass consisting essentially of a silicon mass and a plurality of silicon beads embedded in the silicon mass;
placing the at least one solidified silicon mass into a container;
melting the at least one solidified silicon mass to provide a molten silicon mass in the container; and
producing a silicon ingot from the molten silicon mass.
